(19) United States
(12) Patent Application Publication
(10) Pub. No.: US 2006/0267356 A1
(43) Pub. Date: Nov. 30, 2006

(54) Antipanic handle

(75) Inventor: Cosimo Catalano, Padova (IT)

Correspondence Address: MODIANO & ASSOCIATI, Via Meravigli, 16, MILAN, 20123, IT

(73) Assignee: NOVOFERM SCHIEVANO S.R.L.

(21) Appl. No.: 11/429,193

(22) Filed: May 8, 2006

(30) Foreign Application Priority Data
May 24, 2005 (IT) PD2005U000044

(51) Int. Cl. E05B 3/00

(52) U.S. Cl. 292/336.3

(57) ABSTRACT

An antipanic handle, of the type which comprises a frame to be fixed horizontally to the face of a door to which a longitudinal body, pushable to actuate the lock associated with the door, is rigidly coupled. Advantageously, the antipanic handle comprises at least one photoluminescent element, which is integrated in the pushable longitudinal body in a position which can be viewed by the users of the handle.

The present invention relates to an antipanic handle.

### BACKGROUND OF THE INVENTION

As it is known, antipanic handles are important safety elements, useful for quick and easy evacuation of spaces and premises both in dangerous situations and in case of above-average crowding.

The most widely used antipanic handles include the so-called “panic bar”, which is generally constituted by a bar which is arranged horizontally and ends, at its tips, with two perpendicular arms pivoted to blocks which are fixed to the face of a door, one of said blocks supporting mechanisms for actuating the door lock, and the “push-bar”, a term which defines a handle constituted by a predominantly longitudinally extended box-like frame to be fixed to the face of a door, closed at right angles to the door by a pushable longitudinal element, with which means for actuating the lock of said door are associated.

Such handles are mostly applied to the internal doors or outside doors from which the people crowding an enclosed space are to be evacuated, or to doors known as emergency exits, which are by now present in a very large number of enclosed spaces, such as for example the stairwells of buildings, underground garages, ballrooms, movie theaters, etc.

Many of these enclosed spaces are often scarcely lit or even completely dark; sometimes, especially in emergency conditions, the lack of light is due to failures of the lighting system.

Signs which are visible even in poor lighting conditions are often fixed to the doors with which said handles are associated; the handles are instead mostly in the shadow.

People who have to use these doors in emergency conditions may be forced to act on the handle in a scarcely effective manner, since in addition to the emotional stress of the moment, which causes uncoordinated actions, the poor lighting may not allow to locate the best point to push on the handle in order to operate the door lock.

### SUMMARY OF THE INVENTION

The aim of the present invention is to provide an antipanic handle which solves the problems noted in known types.

Within this aim, an object of the present invention is to provide an antipanic handle which is clearly visible even in scarcely lit or completely dark enclosed spaces.

Another object of the present invention is to provide an antipanic handle which clearly indicates the optimum point to be pressed in order to operate said handle.

Another object of the present invention is to provide an antipanic handle which can be manufactured with known systems and technologies.

This aim and these and other objects, which will become better apparent hereinafter, are achieved by an antipanic handle, of the type which comprises a frame to be fixed horizontally to the face of a door to which a longitudinal body, pushable to actuate the lock associated with the door, is rigidly coupled, characterized in that it comprises at least one photoluminescent element, which is integrated in said pushable longitudinal body in a position which can be viewed by the users of the handle.

### BRIEF DESCRIPTION OF THE DRAWINGS

Further characteristics and advantages of the invention will become better apparent from the following detailed description of a preferred but not exclusive embodiment thereof, illustrated by way of non-limiting example in the accompanying drawings, wherein:

FIG. 1 is a view of a portion of a door with a panic bar according to the invention associated therewith;

FIG. 2 is a partially exploded view of a portion of an antipanic handle according to the invention;

FIG. 3 is a sectional side view of an antipanic handle according to the invention.

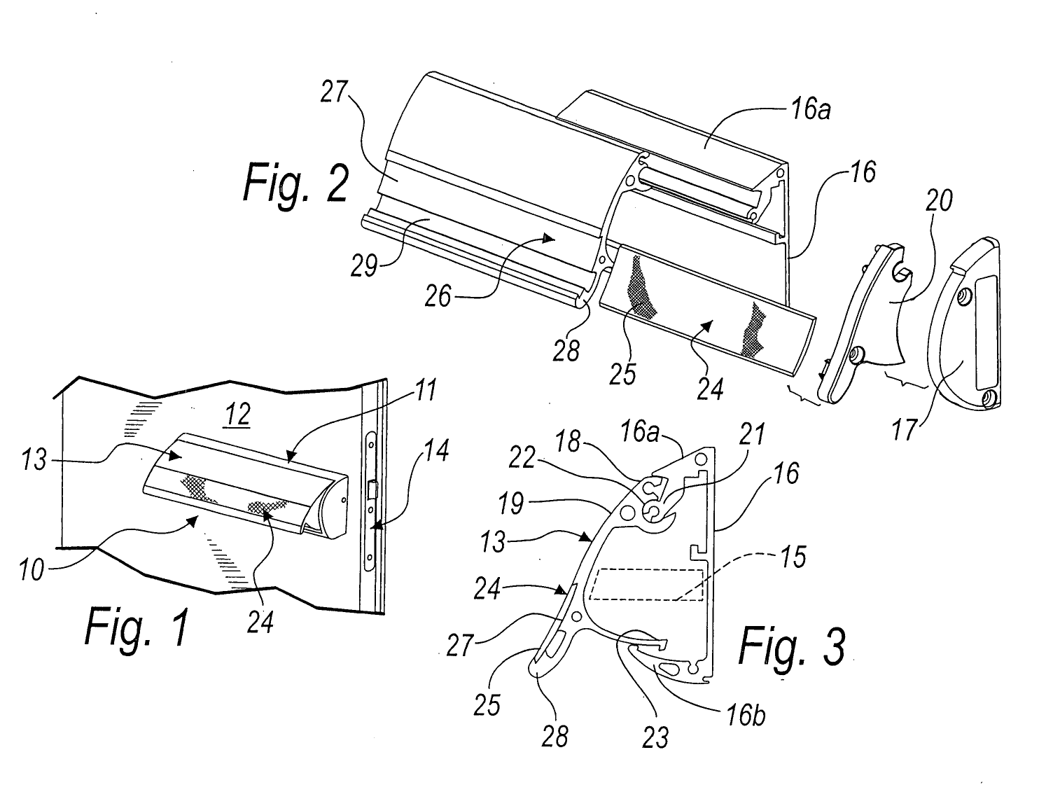

### DESCRIPTION OF THE PREFERRED EMBODIMENTS

With reference to the figures, an antipanic handle according to the invention is generally designated by the reference numeral 10.

The antipanic handle 10 comprises a frame 11, to be fixed to the face of a door 12 to which a longitudinal body 13, pushable to actuate the lock 14 associated with the door 12, is rigidly coupled.

In particular, in this described embodiment, the antipanic handle 10 is of the push-bar type and is substantially similar to the one disclosed in Italian Patent Application PD2004A000300 in the name of this same Applicant, to which reference is made for a more detailed description, particularly as regards the description of the lock actuation means associated with the pushable longitudinal body 13, shown schematically in FIG. 3 by means of a dashed rectangle designated by the reference numeral 15.

According to the same cited description, elastic means for contrasting pressure in the direction of the door (not shown in the figures) are associated with the pushable longitudinal body 13 and ensure the return of the push of longitudinal body 13 into position once it has been pressed in order to open the lock.

The frame 11 has a predominantly longitudinally elongated box-like structure, which is fixed to the face of the door 12 at the lock, with a substantially horizontal orientation.

In particular, the frame 11 is constituted by a longitudinal central plate 16 and, along the longitudinal edges of said plate, by respective longitudinal containment rooms, respectively an upper longitudinal containment rib 16a and a lower longitudinal containment rib 16b.

Detachably associated closure plates 17 are present at the ends of the longitudinal central plate 16.

The box-like structure of the frame 11 is substantially closed, at right angles to the flat extension of the door 12, by the pushable longitudinal body 13, with which the means 15 for actuating the lock 14 of the door 12 are associated.

The pushable longitudinal body 13 is pivoted to the frame 11 substantially along one of its longitudinal edges 18 (for example the upper edge).

In this described embodiment, the pushable longitudinal body 13 is constituted by a central longitudinal element 19, which has a substantially C-shaped profile and is closed at its ends by two plate-like side walls 20 (only one is visible in the Figures).

The plate-like side walls 20 are fixed reversibly to the central longitudinal element 19, for example by means of threaded elements, which are not shown in the figures.

In this described embodiment, the pushable longitudinal body 13 is pivoted at the longitudinal at the upper longitudinal containment rib 16a.

In particular, the pivoting is provided by the coupling of a pivot-like longitudinal portion 21, which is contoured at the end of the longitudinal containment rib 16a, and by a complementary C-shaped cavity 22 formed along the upper longitudinal edge 18.

The lower longitudinal containment rib 16b of the frame 11 protrudes outward more than the upper longitudinal containment rib 16a.

In particular, with the pushable longitudinal body 13 in the non-pushed position, the lower longitudinal containment rib 16b partially overlaps the lower end 23 of the C-shape of the central longitudinal element 19, in order to prevent the possibility of accidental insertion of fingers within the space formed between the frame 11 and the pushable longitudinal element 13 during use of the antipanic handle.

Advantageously, a photoluminescent element 24 is integrated in the pushable longitudinal body 13, in a position which can be viewed by the users of the handle.

Preferably, the photoluminescent element 24 is of the type which can be seen even in the dark, for example phosphorescent, so as to clearly indicate the longitudinal pushable body 13 even in conditions of very low lighting or no lighting of the room in which the door with the handle is located.

It is evident that the invention can use elements which have a different type of photoluminescent nature, useful to clearly indicate the pushable longitudinal body 13 in particular conditions of visibility.

In particular, in this embodiment, the photoluminescent element 24 is constituted by a lamina 25, which is inserted in a longitudinal seat 26 for stable accommodation provided at the region to be pushed by the user of the handle 10.

The lamina 25 is made of plastic material, such as for example PVC, adapted to provide more friction against the hand of the user than the metallic material that forms the pushable longitudinal body 13.

The longitudinal stable accommodation seat 26 is constituted by a longitudinal slot 27, which has a dovetail cross-section which opens outward and is formed within the profile of the central longitudinal element 19 which constitutes the pushable longitudinal body 13.

The lamina 25 is shaped substantially complementarily with respect to the longitudinal slot 27.

The plate-like side walls 20 are fixed to the ends of the central longitudinal element 19 so as to close the longitudinal slot 27 laterally.

In particular, the longitudinal stable accommodation seat 26 (and therefore the longitudinal slot 27) is formed on a lower extension portion 28 of the central portion of the C-shape which forms the longitudinal central element 19.

The portion 28 increases the lever-like action of the longitudinal pushable body 13, making it easier to push it to actuate the lock.

Assembly of the lamina 25 in the longitudinal slot 27 is simple; it is in fact sufficient to insert the lamina 25 in the longitudinal slot 27 by way of the lateral opening provided at one end of the central longitudinal element 19 and then arrange the corresponding plate-like side wall 20 so as to prevent its escape.

In practice it has been found that the invention thus described solves the problems noted in known types of antipanic handle; in particular, the present invention provides an antipanic handle whose pushable longitudinal body is clearly noticeable even in the dark by means of the phosphorescence associated with the lamina 25.

In particular, the photo luminescent element is arranged in the region where the pressure on the part of the user is optimum for operating with minimum effort the mechanisms intended to open the lock.

It is evident that there can be a plurality of phosphorescent elements arranged on the pushable longitudinal body, according to the configuration deemed most convenient for the particular use.

For example, instead of the lamina it is possible to use a series of phosphorescent inserts inserted in a row in said pushable longitudinal body.

In practice, the materials employed, so long as they are compatible with the specific use, as well as the dimensions, may be any according to requirements and to the state of the art.

The disclosures in Italian Utility Model Application No. PD2005U000044 from which this application claims priority are incorporated herein by reference.

What is claimed is:

1. An antipanic handle for a door provided with a lock, comprising: a frame to be fixed horizontally to a face of the door, a longitudinal body pushable to actuate the lock and which is rigidly coupled to said door; at least one photoluminescent element which is integrated in said pushable longitudinal body in a position suitable for the photoluminescent element to be viewed by a user of the antipanic handle.

2. The antipanic handle of claim 1, wherein said photoluminescent element is phosphorescent so as to be seeable in the dark.

3. The antipanic handle of claim 1, wherein said photoluminescent element is constituted by a lamina, said frame being provided with a longitudinally elongated box-like structure, said box-like structure of said frame being closed, at right angles to the door face, by said pushable longitudinal body, said pushable body being provided with a longitudinal seat for stably accommodating said lamina located at a region to be pushed by a user of the antipanic handle.

4. The antipanic handle of claim 3, wherein said pushable longitudinal body is constituted by a metallic profile on which said longitudinal seat is formed, said seat being constituted by a longitudinal slot which has a dovetail cross-section opening outward, said lamina being shaped substantially complementarily with respect to said longitudinal slot.

5. The antipanic handle of claim 4, further comprising two plate-like side walls, which are fixed reversibly to respective ends of said pushable longitudinal body, said plate-like side walls closing laterally said longitudinal slot.

6. The antipanic handle of claim 3, wherein said photoluminescent element is made of plastic material having a surface with friction properties for a hand of a user.

7. The antipanic handle of claim 4, wherein said pushable longitudinal body is constituted by a central longitudinal element, which has a substantially C-shaped cross-sectional profile having a central portion and is pivoted, substantially along an upper longitudinal edge thereof, to said frame, said longitudinal seat for stable accommodation of said photoluminescent element being provided on a lower extension portion of the central portion of the C-shaped profile which forms said central longitudinal element.
